(19) United States
(12) Patent Application Publication
(10) Pub. No.: US 2015/0148137 A1
(43) Pub. Date: May 28, 2015

(54) METHOD OF PROVIDING AN INTERACTIVE ENTERTAINMENT SYSTEM

(71) Applicant: Joel R. Harris, Chicago, IL (US)

(72) Inventor: Joel R. Harris, Chicago, IL (US)

(21) Appl. No.: 14/608,666

(22) Filed: Jan. 29, 2015

Related U.S. Application Data
(63) Continuation-in-part of application No. 14/049,446, filed on Oct. 9, 2013, now Pat. No. 8,972,383.
Application No. 14/049,446 is a continuation of application No. 13/150,667, filed on Jun. 1, 2011, now Pat. No. 8,595,216.
(60) Provisional application No. 61/351,384, filed on Jun. 4, 2010.

(51) Int. Cl. A63F 13/50; A63F 13/80

(52) U.S. Cl. CPC A63F 13/50; A63F 13/80
USPC 463/42

(57) ABSTRACT

This invention relates generally to an interactive entertainment system that provides at least two discrete, independent stories that are interactively intertwined through a variety of online or other interactive media whereby the user of the interactive entertainment system can participate by commenting, by contributing materials (in visual, photographic, video, audio, tactile or other sensory and cognitive formats), by responding to quizzes and polls, and by otherwise interacting with other users of the interactive entertainment system, or with characters in any story, as if the latter were real persons.

### CROSS-REFERENCE TO RELATED APPLICATION

This application is a continuation-in-part of U.S. Non-Provisional application Ser. No. 14/049,446, filed Oct. 9, 2013, which is a continuation of U.S. Non-Provisional application Ser. No. 13/150,667, filed Jun. 1, 2011, now U.S. Pat. No. 8,595,216, which claims the benefit of and priority to U.S. Provisional Application No. 61/351,384, filed Jun. 4, 2010. The entirety of each of these applications is hereby incorporated by reference.

### TECHNICAL FIELD

This invention relates generally to an interactive entertainment system that provides at least one discrete, independent story or game that is interactively intertwined with at least one other discrete, independent story or game, through a variety of online or other interactive media whereby the user of the interactive entertainment system has the opportunity to participate by commenting, by contributing materials (in visual, photographic, video, audio, tactile, or other sensory and cognitive formats), by responding to quizzes and polls, and by otherwise interacting with, and experiencing the participation of, other users of the interactive entertainment system and with character(s) in one or more of the stories (as if the characters were real people).

### BACKGROUND

Games, toys, play structures, and other similar entertainment systems are well known for providing play and interaction among users, whether children or adults. A variety of commercially available play toys, stories, and games are also known for providing valuable learning as well as entertainment opportunities for children and adults, such as role playing, reading, memory stimulation, physical coordination, and the like.

While there are many games, stories, and toys that provide for participants to choose their own ending to a story and for multiplayer online games in which several participants engage in an entertainment system simultaneously and affect one another's experience, there is a lack in the industry of an entertainment system that allows users to follow the individual character(s) of one or more stories within a larger whole involving interwoven stories, to provide feedback regarding, and otherwise engage with, the stories, to interact directly with one or more characters of the stories (as if the characters were real people), to interact with other users and to potentially alter the story of one or more particular characters. Users will be able to communicate with the characters as if the characters were real people. Therefore, a need exists for an online computer or other interactive medium format that provides both an individual entertainment experience (through each user reading and potentially interacting with, in one or more of the ways outlined above, one or more stories within the system with the opportunity to participate in the game component of the entertainment) and a multi-participant experience, whereby users can communicate with one another in various ways and can view the results of other users' participation, and the impact of that participation on individual stories.

### SUMMARY OF THE INVENTION

This invention is directed to an interactive entertainment system that is characterized by a multi-faceted presentation of several stories through a wide range of media. Each story may be fiction, non-fiction or some combination of fiction and non-fiction. The interactive entertainment system may include written, audio, still visuals, animation, video, tactile, olfactory, and other sensory or cognitive means of presentation both of the story content and of the feedback from the users, and includes various online media, e.g. computer, cell-phones, still and motion picture camera, sound recording, and other means and modes of communication.

In one aspect according to the invention, the invention relates to a method, implemented on an interactive entertainment system, for presenting an at least two discrete, independent stories that are interactively intertwined, the method includes uploading an at least two intertwined stories via a content input interface, wherein the at least two stories are made up of a plurality of individual communication units, wherein the at least two stories are two discrete and independent stories that are interactively intertwined. The method further includes storing the plurality of communication units related to the at least two stories in a content database, presenting to a user the at least two stories via a user interface, and receiving a user-feedback from the user via the user interface for any of the at least two stories. The method further includes entering the user-feedback into the content database, providing the user-feedback to a content creator via a feedback interface and uploading an at least one enrichment to an at least one story, wherein the enrichment is based upon the user-feedback.

In one embodiment according to this aspect of the invention, the at least two stories are first-person narratives of individual protagonists of the at least two intertwined stories.

In another embodiment according to this aspect of the invention, the user interface transmits information via at least one medium selected from the group consisting of: a cell phone text message, a visual cell phone transmission, a cell phone voice transmission, a land line voice transmission, a blog posting on a webpage, a micro-blog posting on a webpage, a written, visual, audio or video posting on a webpage, participation in an interactive activity on a webpage, a posting on a social networking website, a video transmitted by a television channel, and an audio transmission transmitted by a television channel or by a radio channel.

In another embodiment according to this aspect of the invention, the feedback interface transmits information via at least one medium selected from the group consisting of: a cell phone text message, a visual cell phone transmission, a cell phone voice transmission, a land line voice transmission, a blog posting on a webpage, a micro-blog posting on a webpage, a written, visual, audio or video posting on a webpage, participation in an interactive activity on a webpage, a posting on a social networking website, a video transmitted by a television channel, and an audio transmission transmitted by a television channel or by a radio channel.

In another embodiment according to this aspect of the invention, the method further includes intertwining an at least one story with an at least one other story, wherein an at least one character from the at least one story sends an at least one individual communication unit to an at least one other character in the at least one other story. In this embodiment, the at least one individual communication unit is transmitted via at least one medium selected from the group consisting of: a cell phone text message, a visual cell phone transmission, a cell phone voice transmission, a land line voice transmission, a blog posting on a webpage, a micro-blog posting on a webpage, a written, visual, audio or video posting on a webpage, participation in an interactive activity on a webpage, a posting on a social networking website, a video transmitted by a television channel, and an audio transmission transmitted by a television channel or by a radio channel.

In another embodiment according to this aspect of the invention, the uploading of the plurality of individual communication units occurs at one or more time points.

In another embodiment according to this aspect of the invention, the method, implemented in a computing system, for presenting at least two discrete, independent stories that are interactively intertwined is repeated more than one time.

In another embodiment according to this aspect of the invention, the method further includes providing the user-feedback from a user. In this embodiment of the invention, the content creator edits the user-feedback from the user prior to providing the user-feedback to the subsequent user. In this embodiment of the invention, the subsequent user responds to the enriched story that includes the user-feedback by providing an additional user-feedback.

In another embodiment according to this aspect of the invention, the method further includes providing a story enhancement to the at least one story based upon the user-feedback.

In another embodiment according to this aspect of the invention, the method further includes providing a plot-advancing communication unit, wherein the plot-advancing communication unit is transmitted via at least one medium selected from the group consisting of: a cell phone text message, a visual cell phone transmission, a cell phone voice transmission, a land line voice transmission, a blog posting on a webpage or mobile application, a micro-blog posting on a webpage or mobile application, a written, visual, audio or video posting on a webpage or mobile application, participation in an interactive activity on a webpage or mobile application, a posting on a social networking website or mobile application, a video transmitted by a television channel, website or mobile application and an audio transmission transmitted by a television channel, a radio channel, a website or a mobile application.

In a second aspect of the invention, the invention relates to a method, implemented on an interactive entertainment system, for providing an enriched experience of presenting a multi-story game to a user, the method including providing a first content database for storing and transmitting a plot-advancing communication unit, wherein the at least two stories are two discrete and independent stories that are interactively intertwined, and wherein the plot-advancing communication unit is related to one or more of the at least two stories. The method further includes transmitting the plot-advancing communication unit from a content creator to the first content database via a content input interface, transmitting the plot-advancing communication unit from the first content database to a user via a user interface, and providing a second content database for receiving a user-feedback, wherein the user transmits the user-feedback via a user interface. The method further includes providing a feedback interface for processing the user-feedback from the second database by the content creator, providing a story enrichment communication unit regarding an at least one story based upon the user-feedback, wherein the content creator transmits the story enrichment communication unit via a content input interface to the first database, and transmitting the story enrichment communication unit to the user via a user interface.

In one embodiment according to this aspect of the invention, the method further includes transmitting the stored information about the at least two stories from the first content database to a user that uses the interactive entertainment system after a first transmission of the plot-advancing communication unit.

In another embodiment according to this aspect of the invention, the user interface transmits information from the first content database via at least one medium selected from the group consisting of: a cell phone text message, a visual cell phone transmission, a cell phone voice transmission, a land line voice transmission, a blog posting on a webpage, mobile webpage or a mobile application, a micro-blog posting on a webpage, mobile webpage or a mobile application, a written, visual, audio or video posting on a webpage or a mobile application, participation in an interactive activity on a webpage, mobile webpage or a mobile application, a posting on a social networking website, mobile website or mobile application, a video or podcast transmitted by a television channel, website, mobile website or mobile application and an audio transmission or podcast transmitted by a television channel, a radio channel, a website, mobile website or a mobile application. In another embodiment according to this aspect of the invention, the user transmits the user-feedback from the user to the second content database via at least one medium selected from the group consisting of: a cell phone text message, a visual cell phone transmission, a cell phone voice transmission, a land line voice transmission, a blog posting on a webpage, mobile webpage or a mobile application, a micro-blog posting on a webpage, mobile webpage or a mobile application, a written, visual, audio or video posting on a webpage or a mobile application, participation in an interactive activity on a webpage, mobile webpage or a mobile application, a posting on a social networking website, mobile website or mobile application, a video or podcast transmitted by a television channel, website, mobile website or mobile application and an audio transmission or podcast transmitted by a television channel, a radio channel, a website, mobile website or a mobile application. In another embodiment according to this aspect of the invention, the user receives an acknowledgment for the submission of the user-feedback to the user interface.

According to certain aspects, the interactive entertainment system may further include at least one game that is intertwined with and corresponding to the at least one story. Like previous aspects, the story includes a plurality of communication units. The communications may be stored in a content database of the system and provided by the content provider. The plurality of communications units relays the story to the user in a variety of formats. For example, the communication units may correspond to one or more characters in the story, one or more plots in the story, or combinations thereof. The game, which corresponds to the story, is likewise stored in a content database of the system and provided by a content provider. The game typically involves one or more obstacles for completion by at least one user. The game includes a plurality of gaming units are used by the users during the game to overcome the obstacles. The gaming units include, for example, a character selected from the story for use in the game, a tool for use in the game, and a gameplay element that affects the course of the game.

The story and the game are provided to one or more users via the user interface. In certain embodiments, the story is provided (partially or entirely) to the user via the user interface as a first webpage, website, mobile webpage, mobile website or mobile application, and the game is provided to the user via the user interface as a second webpage, website, mobile webpage, mobile website or mobile application. The first webpage, website mobile webpage, mobile website or mobile application may be the same as or different from the second webpage, website mobile webpage, mobile website or mobile application. When participating in the story, the user may submit a user communication unit related to the story over the user interface, which is then received by the system. Based on the received user communication unit, the gaming units may be assigned a value (either automatically through logic or by a content provider). In certain embodiments, the assigned value indicates the effectiveness of the gaming unit for completing one of the obstacles of the game. Also, the assigned value can indicate the cost of obtaining the gaming unit for use in the game (e.g., the number of points required for a user to select/use the gaming unit).

A user's participation in the story can carry over to the game, and a user's participation in the game can carry over to the story. In certain embodiments, a user may be rewarded one or more story participation points based on the user transmitting user communication units related to the story. The user may then use the story participation points to enhance their gaming experience. For example, the user may request to exchange a story participation point for at least one gaming unit. Based on the user request, the system may transmit a gaming unit for the user, which in turn can be used by the user during the course of the game. In certain embodiments, when a user completes an obstacle in a game, the content provider may generate communications units for the story corresponding to and in response to the completion of the game obstacle. For example, a story enrichment unit may be generated, uploaded, stored, and transmitted in response to a user completing an obstacle in the game. The story enrichment unit can be used to modify a plot or a character of the corresponding story. In this manner, the user's participation in the game directly affects the story of the entertainment system.

The values assigned to a gaming unit may be based on one or more factors. In some embodiments, a value is assigned to a gaming unit based on a user communication unit that was sent by the user in response to the story. For example, one or more users may send user communication units that indicate the users' fondness for a certain character. If the character is liked, the system, in turn, may increase the value of that character within the game (i.e. value of the character gaming unit). The increased value of the character may translate to an increase in that character's usefulness/effectiveness in the course of playing the game or an increase the cost (e.g., in gaming points, story participation points, money, etc.) for obtaining the character. In other embodiments, a value is assigned to a gaming unit based on an aggregation of user communication users that were sent by a plurality of users in response to the story. In such instances, the aggregation of user communication units may produce one or more statistics about a character, plot, element in the story, etc. The statistics may reflect the strengths, weaknesses, popularity, etc. of the character, plot, element in the story, etc. A value is then assigned to a gaming unit based on the statistics, which value may increase the gaming unit's effectiveness and/or cost in the game.

As with other aspects and embodiments, the user communication unit may be a communication with a story character(s), a communication with other user(s), commentary regarding the character(s) or plot(s), and participation in a poll or quiz. The user communication units (i.e. sent by a user), the story communication units (i.e., sent by a content provider), or both may be transmitted/provided in several different mediums, including a cell phone text message, a visual cell phone transmission, a cell phone voice transmission, a land line voice transmission, a blog posting on a webpage, webpage, mobile webpage or a mobile application, a micro-blog posting on a webpage, mobile webpage or a mobile application, a written, visual, audio or video posting on a webpage or a mobile application, participation in an interactive activity on a webpage, mobile webpage or a mobile application, a posting on a social networking website, mobile website or mobile application, a video or podcast transmitted by a television channel, website, mobile website or mobile application and an audio transmission or podcast transmitted by a television channel, a radio channel, a website, mobile website or a mobile application

### BRIEF DESCRIPTION OF DRAWINGS

FIG. 1 is a block diagram of an embodiment of a method, implemented on an interactive entertainment system, for presenting at least two discrete, independent stories that are interactively intertwined.

FIG. 2 is a block diagram of an embodiment of a method, implemented on an interactive entertainment system, for providing story enrichment to a game involving at least two discrete, independent stories that are interactively intertwined.

FIG. 3 is a diagram of the entertaining system with gaming and story platforms, according to certain embodiments.

FIG. 4 illustrates a user participating in the story of the interactive story and gaming entertainment system, according to certain embodiments.

FIG. 5 illustrates a user participating in the game of the interactive story and gaming entertainment system, according to certain embodiments.

### DETAILED DESCRIPTION

In general, the present invention provides that each story and/or game included in the interactive entertainment system can be accessed in at least one computing system format, such as cellular phones, mobile Internet, and standard computers. The one or more stories may be fiction, non-fiction or some combination of fiction and non-fiction. The one or more games relate to the stories and involve one or more obstacles for completion by a user. Each game may correspond to characters or plots in a story or correspond to characters and plots spanning across a plurality of stories. The stories and corresponding games may be based on known literature or real-world events.

A user receives both plot-advancing and additional interactive entertainment system-related communication units that are conveyed to the user via transmissions such as, for example, a text message; a visual cell phone transmission; a blog; a micro-blog; a written, graphic, photographic, or other work of visual art; audio or video posting on a webpage; participation in an interactive activity via a webpage, via a cell phone response, via a phone-in response to a television transmission, via a two-way auditory transmission; a posting on a social networking website; a video posted on a website transmitted by a television channel or transmitted by cell phone; or an audio transmission posted on a website transmitted by a television channel, transmitted by a radio channel, transmitted by two-way auditory transmission. Plot-advancing communication units include communication units which move a story forward in terms of the development of the plot, as distinguished from other communication units which may digress into areas of interest of users and/or characters but which do not contribute to the development of the story's plot.

Participation in an interactive activity includes engagement in activities such as the following: communicating with a character in a story in the interactive entertainment system, communicating with another user of the interactive entertainment system, engaging in joint activities with one or more other users of the interactive entertainment system, responding to a quiz or a poll, entering a contest, making a virtual purchase, creating and/or embellishing a personal avatar, or otherwise participating in any interactive entertainment system-related virtual or actual activity available to a user, including attendance at virtual or actual events.

A communication unit is the information provided at one time through one type of medium. For example, a written communication by micro-blog or text message constitutes a communication unit; equally a photograph, sound recording or video presentation on a website or sent to a cell phone constitutes a communication unit. A character may be a protagonist; however, a character may also be a non-protagonist.

Once a story has been in existence long enough for a number of communication units to be available, users may select how they would like to follow a character's story, thus providing each user the opportunity to have a unique and individualized experience with each interactive story. For instance, if users join the interactive entertainment system after one or more stories have already progressed and wish to understand some of the previous events, plot twists and enrichment based on other users' input, they can explore previously posted communication units in any order they choose, even though what they experience would not necessarily be temporally sequential. Certain previously posted communication units that enable a late-entering user to catch up may also be available through one or more media such as a website displaying aspects of the interactive entertainment system, an online Twitter or similar micro-blog site, online in an audio format or any other computerized format that may be suitable to update the user on what they have missed. The interactive entertainment system may also have a summary “catch-up” mechanism that provides an abbreviated overview of a story to date that may be available through one or more media such as a computer website or mobile internet site, a character's social network site or online in an audio format or any other computerized format that may be suitable.

Alternatively, the user may wish to follow a chain of interaction among different story characters and other users related to a particular topic that may follow the main plot or may be a diversion from the main plot development, to character relationships, to character's motives or to discovering clues, solutions or answers to unresolved issues or unanswered questions within a particular story or at least two intertwining stories. Intertwining stories are two or more independent, discrete stories in which one or more characters from one story communicate with one or more characters from one or more of the other stories, so that characters can communicate with one another across separate stories regarding story elements from any of the stories in which they are involved. In another alternative, a user may choose to follow one or more stories in a temporally sequential fashion.

Further, the interactive entertainment system enables users to participate in the story to whatever degree they choose. As an incentive to participate, users are rewarded for their participation and contributions. Users can, for example, engage with and respond to characters' micro-blog postings, blogs and social networking pages, include characters among their social networking site friends, download images from the interactive entertainment system onto their own social networking pages, respond to polls related to issues in one or more stories, answer quizzes that demonstrate commonalities between the users and the characters, communicate with another user of the interactive entertainment system, engage in joint activities with one or more other users of the interactive entertainment system, enter a contest, make a virtual purchase, create and/or embellish a user's personal avatar, or otherwise participate in any interactive entertainment system-related virtual or actual activity available to a user, including attendance at virtual or actual events.

The user's participation may provide them with rewards that enable them to participate in other ways. One of the rewards for participation may be to receive additional information that is not part of the generally available story, and would be sent directly to that user through a personalized medium such as email, text message or cell phone message.

Each character with an active communication presence presents his, hers, or its experiences in the form of a “first-person” narrative so the interactive entertainment system constitutes a multiply-threaded set of such narratives, all of which intertwine with one another, as the characters respond to each other's blogs, tweets, and other communication units in real time. A character with an active communication presence is a character that sends out at least one communication unit; a character without an active communication presence is a character included in the story that does not send out any communication units. Additionally, third-person communication units, such as mock news stories or real weather information for geographic locations relevant to a particular story, may be transmitted as related to one or more stories.

Individual character's online postings on user interfaces other than on the interactive entertainment system, such as micro-blog postings on sites such as Twitter or postings on a social networking site, will also be reproduced on, or linked to, the interactive entertainment system, through, for example RSS feeds under current technology, although this may change with new technological advances. The interactive entertainment system includes links to the individual character's blog sites, to a character's social networking site pages, and to visual and audio material on other sites. Audio versions of the written communication units as well as related music, sound, tactile, olfactory, or other sensory and cognitive messaging for plot development may also be provided by the interactive entertainment system.

As the stories progress, users receive user-based and content-creator story enrichment communication units. Story enrichment units include content reflecting user-feedback; communication units from one character to another, impacting both character's stories; or real or mock third-party information (such as a mock news story) about a specific character or affecting one or more stories. Story enrichment can be presented in written, audio, photographic, graphic, animation, and/or video formats.

Communication units from one character to another can be transmitted by various media, such as the characters' individual blogs; the characters' “tweets” (i.e., short micro-blog messages on Twitter or similar sites); mock “instant messaging” communications such as those on Gmail; postings on characters' pages on social networking sites, videos and graphics (such as slide presentations) posted on YouTube.com and similar video-sharing websites or transmitted on a television channel, or audio (such as “found sounds”) and music posted on audio-sharing websites, transmitted by a television channel, transmitted by a radio channel, or transmitted by two-way auditory transmission

Once a user provides initial content via a communication unit, and that content is edited and subsequently uploaded, it is available—visually, auditorily, or sensorily (depending on the type of communication unit provided by that user)—to all subsequent users. Once a user initially responds to a participation activity such as a poll, the result of that participation is available to subsequent users. Subsequent to the initial user who provided content via a communication unit or other information via a participatory activity, each later user therefore experiences an enriched experience to which that later user will have the opportunity to respond. Each subsequent user who also provides content via one of these modalities further enriches the experience of users subsequent to that user. The method also includes feedback contributed by the content creator as if it were communicated by one character to another character in two intertwining stories within the interactive entertainment system. This content creator-generated “character” feedback includes responding to feedback from one or more users as well as responding to previous content creator-generated “character” communication. This process of communication and response is ongoing so that there is a continuing feedback loop of information being entered into the interactive entertainment system.

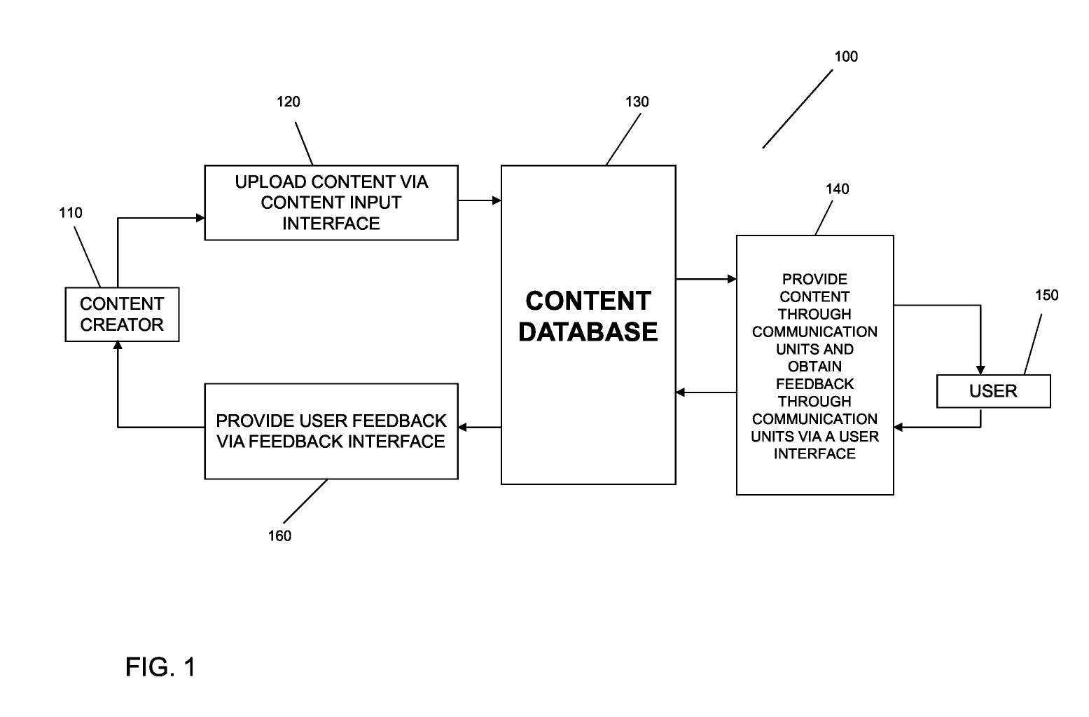

Referring to FIG. 1, in one embodiment of the invention, a method 100 implemented on an interactive entertainment system, for presenting at least two discrete, independent stories that are interactively intertwined is shown. According to the method, a content creator 110 uploads content via a content input interface 120. The content is stored in a content database 130. According to the invention, content includes content creator-generated plot advancing and other communication units. User feedback in the form of communication units approved by the content creator 110, results of polls and quizzes, or any other information to enrich the entire interactive entertainment system. The content can be stored as individual communication units. Individual communication units include anything communicated by a form of media, such as, for example, a sound, a written message, a photograph, a video, a recording, or a micro-blog.

When a user 150 chooses to participate in the story, the user accesses participation opportunities through a user interface 140 which may be on any medium (such as, for example, the interactive entertainment system computer website or its mobile Internet website, a character social networking page, a video-sharing website) that provides communication units from one or more stories from the content database 130 to the user 150. If the user 150 wishes to provide any feedback regarding one or more stories, or any other aspect of any story or individual character, or if the user 150 participates in any participation activity such as a poll or quiz or virtual store, they provide feedback to the content database 130 via a user interface 140. The user may submit feedback or access story communication units via any medium of transmission that is relevant to the type of communication unit being transmitted, such as, for example, via a text message, a visual cell phone transmission, a blog, a micro-blog, a posting on a webpage, participation in an interactive activity on a webpage, a posting on a social networking website, a video on a video sharing website or an audio recording on an audio-sharing website.

The content database 130 then provides the user feedback to the content creator 110 via a feedback interface 160 for the content creator 110 to review and decide to provide to other users (in the case of written, visual or auditory material related to a character or a story), to aggregate in order to provide summary information (in the case of responses to polls and quizzes, for example) or to implement (in the case of a virtual purchase or an embellishment of a user avatar, for example.) The user-feedback is initially stored in the content database 130 and is subject to an editorial process by the content creator 110 that includes content approval and possible editing and tools for aggregation by an entertainment system manager.

The content creator 110 may alter one or more stories based upon user feedback and may upload new communication units providing narrative twists to the story, additional character development, or any other story enrichment via the content input interface 120 to the content database 130 for further distribution to a user 150. Communication units may be repeatedly provided to a user 150.

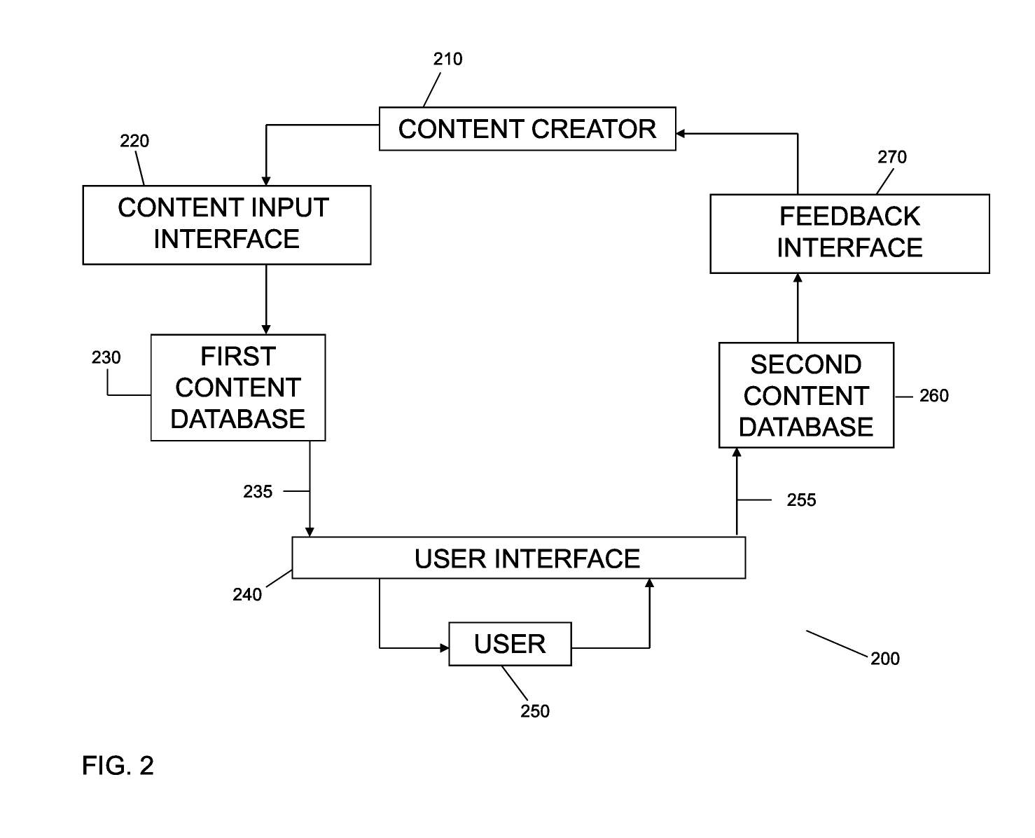

Referring to FIG. 2, in another embodiment of the invention, a method 200 implemented on an interactive entertainment system, for providing a user with one or more of at least two discrete, independent stories that are interactively intertwined and that include story enrichment in a multi-story game is shown. The method facilitates user-generated story enrichment regarding the plot, the character(s) and other issues related to each story, wherein the user feedback (whether in the form of communication units in written, visual, auditory or some other sensory format related to a character or a story, in the form of responses to polls and quizzes or similar communication units that can be aggregated or in the form of personalized user participation such as a virtual purchase or user embellishment of the user's avatar) is transmitted to the content creator who then processes the user feedback as appropriate to the type of feedback and who may also modify the plot, the character(s) and other issues related to that story in response to the user feedback.

According to the method, a content creator 210 provides plot-advancing and other communication units about one or more characters in at least one of at least two discrete, independent stories that are interactively intertwined in a game to a first content database 230 via a content input interface 220. The first content database 230 is used for storing and distributing the communication units to a user 250 of the game. The plot-advancing and other communication units about one or more characters in at least one of at least two discrete, independent stories that are interactively intertwined are transmitted from the first content database 230 to the user via a user interface 240 (which will vary depending on the medium through which the communication units are transmitted to and from the user) through a communication line 235 between the first content database 230 and the user interface 240.

The method 200 further provides for a user 250 to provide feedback regarding the game, such as, for example, communication units in written, visual, auditory or some other sensory format related to a character or a story; responses to polls and quizzes or similar communication units that can be aggregated; or personalized user participation such as a virtual purchase or user embellishment of the user's avatar or any other information or user reaction, the user 250 may transmit regarding the game. The feedback from the user 250 is transmitted via a user interface 240 to a second content database 260 though a communication line 255 between the user interface 240 and the second content database 260. The user feedback is then transmitted to the content creator 210 from the second content database 260 via a feedback interface 270. The content creator 210 can then review the user feedback and respond in one or more of the following ways: (a) evaluate, and possibly edit the feedback provided and potentially add enrichment to the game, such as, for example, changes in a story's plot or, information about a character (in the case of user feedback in the form of communication units in written, visual, auditory or other sensory format related to a character or a story), (b) aggregate the user feedback in order to upload summary information (in the case of responses to polls and quizzes, for example), or (c) to implement (in the case of user feedback in the form of a virtual purchase or an embellishment of a user avatar, for example.) The content creator 210 then provides the relevant information based on the user feedback to the user 250 by enriching the interactive entertainment system in one or more of the three ways outlined above and then repeating the steps of the method 200 with the next communication unit of user feedback.

Further aspects of the invention may include contests related to the interactive entertainment system, with user's material being included as part of the multi-media content of the interactive entertainment system, such as, for example, original music or visuals produced for the contest. External prizes for users and contest winners may be provided, some of these coming from interactive entertainment system sponsors or partners. The contests may be collaborative efforts on partnering websites; they may be posted by the interactive entertainment system enterprise on social network sites; or there may be other formats for the contests, such as via text message or other communication media.

Users may also earn story participation points for submitting any user communication unit, which include communicating with one or more other users on the system, communicating with one or more story characters, participating in polls and quizzes, commenting on characters' blogs, commenting on the story site based on one or more plots of the story, or for other types of participation in the interactive entertainment system. The story participation points may provide further opportunities for participation such as, for example, the opportunity to make a virtual purchase or to embellish a user's avatar. Users may also receive an acknowledgement for the submission of the user feedback to the user interface. The acknowledgment may be from the content creator or one of the characters and may be, for example, an email, short micro-blog response, or a text message, thanking the user for their contribution to the interactive entertainment system. Users may be offered the opportunity to vote on fixed choice decisions, such as yes/no questions, relevant to the interactive entertainment system. In addition, users may be able to download interactive entertainment system music, including ring tones, and visuals, such as screensavers; and they may be offered the opportunity to purchase objects such as licensed character tee-shirts and totes from the interactive entertainment system website or from collaborating partner or sponsor websites.

According to certain aspects, the interactive entertainment system may further include at least one game that is intertwined and corresponds with one or more of the stories. The game may likewise be stored in the content database of the system and provided by the content provider to users over the user interface. In certain embodiments, the story is provided (partially or entirely) to the user via the user interface in a first medium, and the game is provided to the user via the user interface in a second medium. The first medium may be the same as or different from the second medium. Usually, the first and second mediums are a webpage or website, but other mediums may be used as described above. The game typically involves one or more obstacles for completion by at least one user. The game may incorporate one or a combination of known gaming genres, for example: action (involving a variety of sequences-fighting, stunts, car chase, explosions), adventure (strategic quests or obstacles carried out in adventurous environments), fighting (i.e. physical combat), racing (car, horse, running, etc.), role playing (assuming a role in a story itself), simulation (mode of game stimulates real-life activity), sport (competitive-related to football, soccer, basketball, etc.), strategy (require tactics, like chess and Risk), parlor (dice, card games, etc.), rhythm (music-based) or traditional (adaptation of non-computer game-pinball, board games).

The games or obstacles in the games may be related to the characters or plots in the stories. For example, a plot in one of the stories may involve a missing character, and the game may include obstacles directed to finding the missing character (such as finding clues related to the missing character, sending communication units to other story characters about the missing character, or conducting a mission to retrieve the missing character in the virtual environment of the entertainment system). In another example, the game may be directed to solving a problem currently faced by a character in the story. A character's participation in the story may be in limbo until one or more users complete a particular obstacle, and completion of the obstacle unlocks the character and allows that character's participation in the story to continue. In yet another example, the plot of a story may involve a burglary, and the obstacle of the game may involve retrieving the thief or the stolen goods. In other embodiments, the game may not relate to the story or its plots/characters, but completion of the game or its obstacles may result in gaming or story-related benefits to the user. For example, a user must complete a series of non-related strategy games before receiving additional story communication units from the content provider.

The games or obstacles of the game may be played by one or more users. Each game or obstacle may be directed to one-person play, two-person play, or multi-person play. Games involving two or more users may involve users competing directly against each other or may involve users working together to complete an obstacle.

According to certain embodiments, the one or more games may include a plurality of gaming units. The gaming units are selected by the user and can be used while playing the game. The gaming units include features used by the player when playing the game, features, used to progress the game or features used advance the user's position in the game. For example, the gaming units include characters selected from a story for use in the game, tools for use in the game, and gameplay elements that affect the game. These gaming units are described in more detail hereinafter.

When a user receives or selects a character gaming unit, the character may be, for example, used by the user to carry out or complete the game or obstacle (e.g. character performs the task under the direction of the user) or the character may be a virtual partner with the user's own avatar to carry out or complete the game or obstacle (e.g. character works with the user-directed avatar). Characters from the stories may have different strengths, weaknesses, and abilities that would make certain characters ideal and effective for carrying out or completing a game or obstacle. A user may be assigned or may select a character gaming unit for use in the game. When a user receives or selects a tool gaming unit, the user may use that tool to advance the user's progress in the game. The tool gaming unit may include a hint for completing a strategic obstacle, a virtual object for use by a character or an avatar in completing an obstacle (e.g., a car, a superpower, a weapon, etc.). A gameplay element is any other feature received by a user that affects the course of the game. Unlike character or tool gaming units that are used to carry out the game obstacle, gameplay elements may not always be directly used to carry out gaming activities. Exemplary game play elements include an additional life for a character, a pass to skip an obstacle in the game, a token to block the activities of another player, an immediate award of gaming points (which can be used for example to buy character or tool gaming units).

The gaming units may be assigned values. An assigned value may relate to the gaming unit's effectiveness in carrying out or completing the game or an obstacle in the game, the gaming unit's popularity in the story or game, etc. In certain embodiments, gaming units that are useful in completing an obstacle or game are assigned a high value and less useful gaming units are assigned a lower value. In some embodiments, gaming units that are popular in the story may be assigned a high value, regardless of the usefulness of the gaming units in completing the task. In further embodiments, gaming units may be assigned a plurality of values. For example, a gaming unit may be assigned a first value based on popularity, a second value based on an attribute/skill, a third value based on another attribute/skill, etc. Any scale can be used to assign values to the gaming units. The scale can range, for example, from 1-10, 1-100, etc.

According to certain embodiments, the assigned value may be based on the aggregation of user feedback/participation in the story. The aggregated value can be based on a number of user communications sent by one user. Alternatively, the aggregated value can be based on a number of user communications sent by a plurality of users. In some embodiments, the system may aggregate any number of user communication units (e.g., through answering polls, sending character communications—texts, tweets, emails, buying character or plot-related virtual or real merchandise, answering quizzes, etc.) to produce one or more statistics about a character, plot, element in the story, etc. The statistics may reflect the strengths, weaknesses, popularity, etc. of the character, plot, element in the story, etc. A value is then assigned to a gaming unit based on the statistics, which value may increase the gaming unit's effectiveness and/or cost in the game.

For example, several users may take a poll regarding a particular character. The poll may provide insight into that particular character's strength and weaknesses perceived by the users. That particular character may also have a high volume of direct communications from users. The poll results and the high volume of direct communications can be factored and weighed to produce a statistical value associated with that particular character.

In certain embodiments, the values assigned to the gaming units correspond to the relative “cost” of the gaming unit, in terms of points or money. For example, gaming units may be available to a user in exchange for points or money, and the value represents the amount of points or money a user must pay to purchase a gaming unit. Gaming units with high values may cost more points or money than gaming units with mid- to low values.

Points that are redeemable for gaming units include, for example, story participation points, gaming points, and points available for purchase (i.e. virtual money). Story participation points are discussed above, and generally include points rewarded to a user for his/her participation in the story (for example, communicating with the one or more characters in at least one of the stories, communicating with one or more other users, providing commentary regarding the one or more characters or the one or more plots, and participating in a poll or quiz). Gaming points include points rewarded to a user over the course of the user playing the game. Gaming points may be rewarded for completing certain obstacles, uncovering reward caches while playing game (e.g. finding a treasure chest in a digital gameplay environment), courteous gameplay with respect to other users, etc. In addition, points may be available to a user for purchase at any time and such points may be redeemed for gaming units and other game-related or story-related items (e.g., merchandise, downloads, etc.).

Preferably, points (story participation, gaming, and purchased) may be redeemed at either the gaming website or story website for gaming units, merchandise, and other items related to the game and story. In some embodiments, story participation points may only be redeemed for items related to the story or items sold at story website/page, mobile website/page or mobile application, and game participation points may only be redeemed for items related to the game to or items sold at the game website/page.

It is understood that real world or virtual merchandise may be purchased using points, virtual money, or real world money. Real world merchandise may include physical merchandise, such as clothing, accessories, board games, electronics, books, etc. Virtual merchandise may include anything accessible online, including downloadable applications, songs, avatars, emoticons, podcasts, stories, etc.

A user's participation in the story can correspond to the game, and vice versa. In certain embodiments, when a user completes an obstacle in a game, the system may generate communications units for the story corresponding to and in response to the completion of the obstacle. For example, a story enrichment unit may be generated, uploaded, stored, and transmitted in response to a user completing an obstacle in the game or the game itself. The story enrichment unit can be used to modify a plot or a character of the corresponding story. In this manner, the user's participation in the game directly affects the story being set forth over the system. In another example, user participation in the story may result in a plot or character modification in the story. The plot or character modification may then translate to the game. For example, an obstacle in the game related to the modified plot may be removed or likewise modified.

In further embodiments, the content provider may modify the game or the plot based on real-world events that are unrelated to the user's participation in the story and/or game. For example, an earthquake may hit California in real-life, and the content provider may modify the game or story to incorporate a storyline or obstacle that focuses on the real-life earthquake.

In further embodiments, virtual merchandise purchased in relation to the story or purchased from the story website may be used to play the game. For example, avatars purchased from the story website may be used to play the game.

The following figures are schematic diagrams of the game and story interactive entertainment system, according to certain embodiments and as described above. The schematic diagrams are meant to illustrate particular embodiments of the entertainment system, and are not meant to limit the entertainment system.

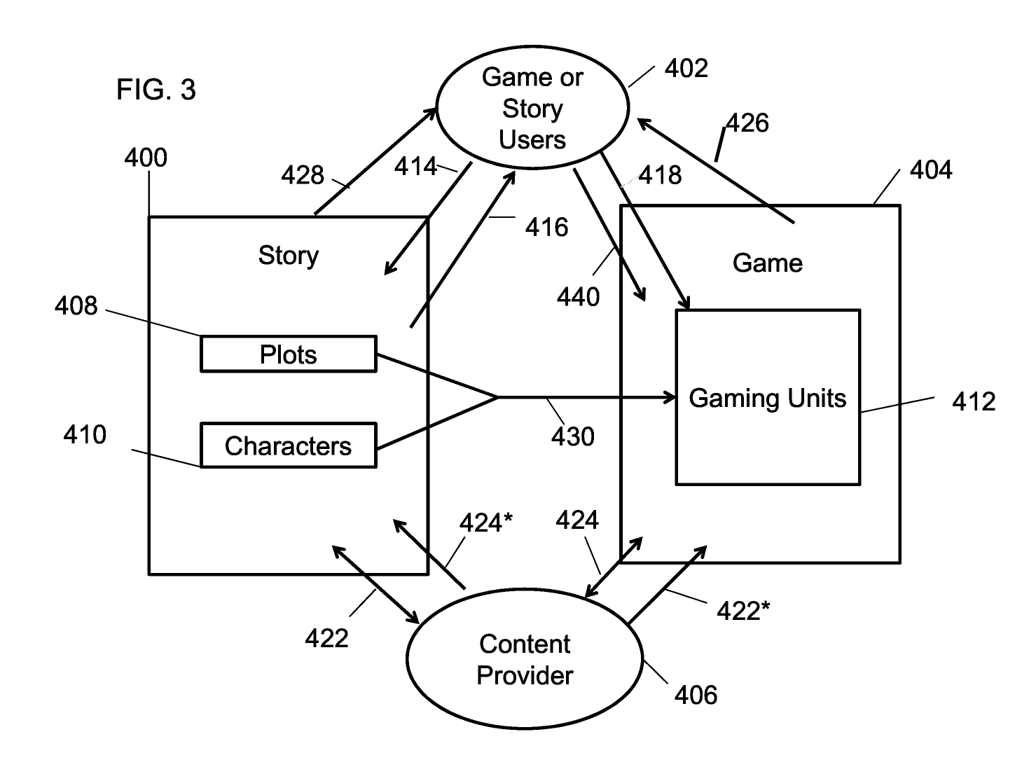

FIG. 3 illustrates a basic diagram of the interactive system with a story and a game. The entertainment system includes a story 400 (such as a story website) and a game 404 (such as a gaming website). The story 400 and game 404 are stored in a content database and are uploaded by a content provider (e.g., writer, story and game site developers/designers, etc.). The story 400 includes one or more plots 408 and one or more characters 410. The plots 408 and characters 410 are conveyed to a user 402 in the form of communication units over a user interface. The game 404 is related to the story 400, and provides one or more obstacles for the users 402 to overcome. Users 402 participating in the story 400 can, for example, 1) receive communications units that correspond to the plots 408 or the characters 410 (as indicated by arrow 416); 2) send user communication units to the story 400 (as indicated by arrow 414); receive or buy story points, such as story participation points, reward points, or virtual money (as indicated by arrow 428). The game 404 includes one or more gaming units 412. The gaming units 412 are utilized by the user 402 to play the game 404. The gaming units 412 may be assigned values 430 (as indicated by arrow 430) based on the plots 408 and characters 410. The assigned values 430 may be based on the aggregation of user participation in the story. Users 402 participating in the game can, for example, 1) select gaming units for use in playing the game (as indicated by arrow 418); 2) receive gaming points for playing the game to buy further gaming units on the gaming site 402 or to buy merchandise on the story 400 site (as indicated by arrow 426); 3) use story points to select gaming units of particular values (as indicated by arrow 440).

Content Provider 406 continually progresses or modifies the story 402 or game 404. As indicated by arrow 422, the content provider 406 receives user feedback (e.g., in form of user communication units) and sends story communication units that progress or modify the plots 408 or characters 410 of the story based on the user feedback. The content provider 406 may also progress or modify the game based on the user feedback (as indicated by arrow 422*). As indicted by arrow 424, the content provider 406 1) receives the user's gaming results and preferences for gaming units 412, and 2) may progress or modify the game based on the user's gaming results and preferences for gaming units 412. The content provider 406 may also progress or modify the story based on the user's gaming results and preferences for gaming units 412 (as indicated by arrow 424*).

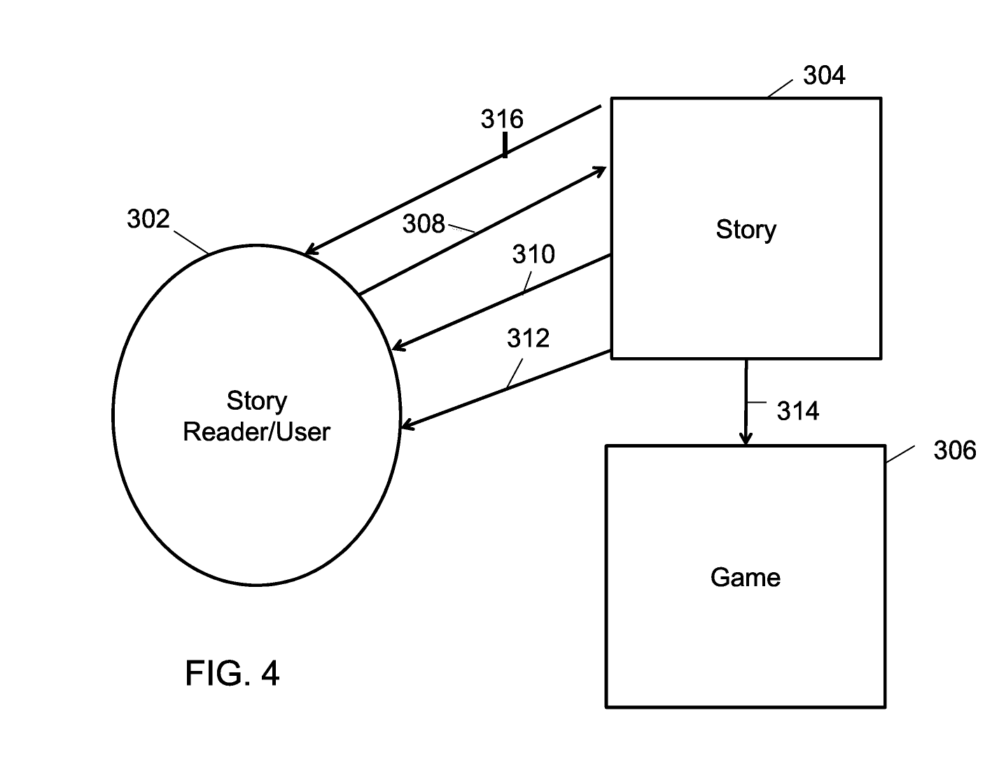

FIG. 4 illustrates a user participating in the story of the interactive story and gaming entertainment system, according to certain embodiments. As indicated by arrow 316, a user 302 receives communication units from the story 304 (e.g., story website), which may relate to the story plot or characters. As indicated by arrow 308, the user 302 participates in the story 304 by sending user communication units. The content provider may progress or modify the story 304 based on the user communication units 308. Based on the user participation, the user 302 may receive story points (as indicated by arrow 310) and use the story points to purchase story related merchandise (as indicated by arrow 312). Based on the user participation in the story 304, the content provider may progress or modify the game 306 (as indicated by arrow 314).

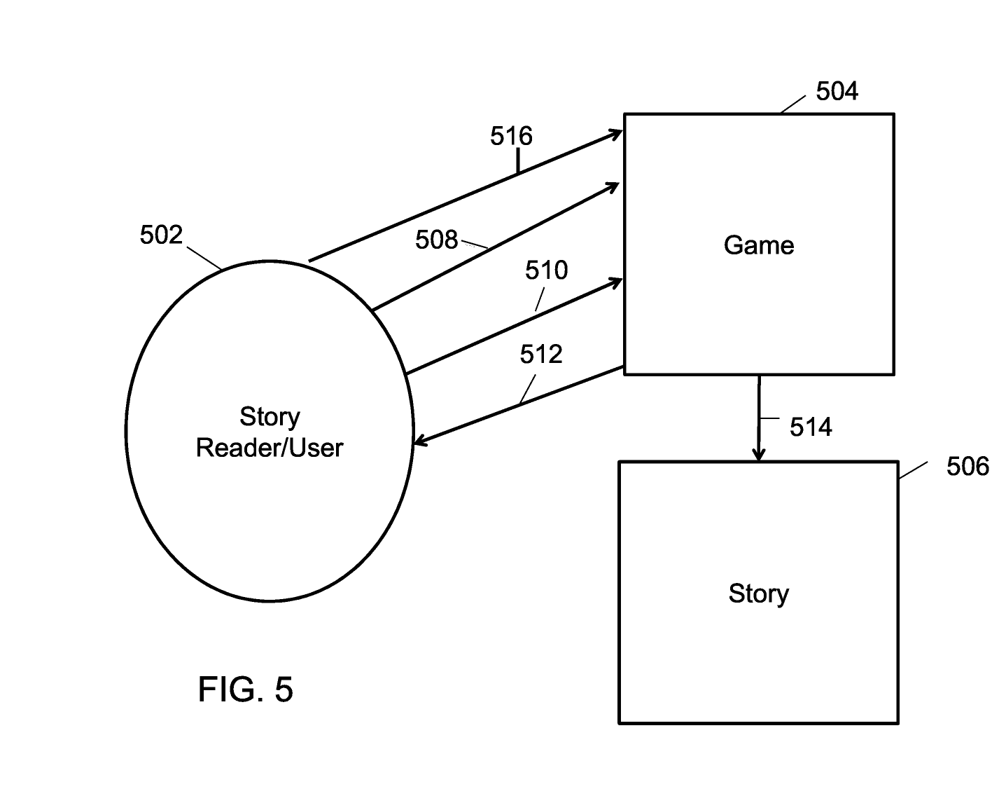

FIG. 5 illustrates a user participating in the game of the interactive story and gaming entertainment system, according to certain embodiments. As indicated by arrow 516, a user 502 may select gaming units to play the game 504 (e.g. select free gaming units—those that do not require points for purchase). As indicated by arrow 508, the user 502 may also purchase gaming units using points earned from previous participation in the story 506 (story participation points). As indicated by arrow 512, the user 502 may be rewarded gaming points 512 earned by overcoming obstacles in the game. As indicated by arrow 510, the user 502 may use the gaming points to purchase gaming units. As indicated by arrow 514, the content provider may progress or modify the story 514 based on the user's gaming results and preferences for gaming units. Likewise, the game 504 itself may be modified or progressed based on the user's gaming results and preferences for gaming units.

It will be understood that various modifications may be made to the embodiments disclosed herein. Therefore, the above description should not be construed as limiting, but merely as exemplifications of the various embodiments of the present disclosure. Those skilled in the art will envision other modifications within the scope and spirit of the claims appended hereto.

What is claimed is:

1. An entertainment system for providing an interactive story and an interactive game to one or more users over a computing device, the system comprising a memory and a processor configured to:
store at least one story comprising a plurality of communication units in a content database, wherein a portion of the communication units corresponds to one or more characters in the story and a portion of communication units corresponds to one or more plots in the story;
store at least one game corresponding to the story in the content database, wherein the game involves one or more obstacles for completion by at least one user and comprises a plurality of gaming units, wherein one or more gaming units are selected from the group consisting of a character selected from the story for use in the game, a tool for use in the game, and a gameplay element affecting the course of the game;
provide the story and the game to a user via a user interface;
receive a user communication unit related to the story from the user via the user interface; and
assign a value to a gaming unit based on the received user communication unit.

2. The entertainment system of claim 1, wherein the at least one story is provided to the user via the user database as a first webpage or website and the at least one game is presented to the user via the user database as a second webpage or website.

3. The entertainment system of claim 1, wherein the user communication unit is selected from the group consisting of a communication with the one or more characters in at least one of the stories, a communication with one or more other users, commentary regarding the one or more characters or the one or more plots, and participation in a poll or quiz.

4. The entertainment system of claim 1, wherein the system is configured to transmit the plurality of communication units from the content creator via at least one medium selected from the group consisting of: a cell phone text message, a visual cell phone transmission, a cell phone voice transmission, a land line voice transmission, a blog posting on a webpage, a micro-blog posting on a webpage, a written, visual, audio or video posting on a webpage, participation in an interactive activity on a webpage, a posting on a social networking website, a video transmitted by a television channel, and an audio transmission transmitted by a television channel or by a radio channel.

5. The entertainment system of claim 1, wherein the system is configured to send a story enrichment unit in response to the completion of one of the obstacles of the game, wherein the story enrichment unit modifies a plot or a character of the at least one story.

6. The entertainment system of claim 1, wherein the value indicates the effectiveness of the at least one gaming unit for completing one of the obstacles of the game.

7. The entertainment system of claim 1, wherein the system is further configured to transmit, over the user interface, a story participation point to the user in return for the received user communication unit.

8. The entertainment system of claim 7, wherein the system is further configured to:
receive from a user a request to exchange the story participation point for at least one gaming unit; and
transmit, over the user interface, a gaming unit to the user in exchange for the story participation point.

9. The entertainment system of claim 1, wherein the one or more obstacles are completed by a single user or a plurality of users.

10. A method, implemented on an entertainment system, for presenting at least one enriched, interactive story, the method comprising the steps of:
uploading, by a content creator, at least one story via a content input interface, wherein the story comprises a plurality of communication units in a content database, wherein a portion of the communication units corresponds to one or more characters in the story and a portion of communication units corresponds to one or more plots in the story;
uploading, by a content creator, at least one game via content input interface, wherein the game involves one or more obstacles for completion by at least one user and comprises a plurality of gaming units, wherein one or more gaming units are selected from the group consisting of a character selected from the story for use in the game, a tool for use in the game, and a gameplay element affecting the course of the game;
storing the story and the game in a content database;
providing the story and the game to a user via a user interface;
receiving a user communication unit related to the story from the user via the user interface; and
assigning a value to a gaming unit based on the received user communication unit.

11. The method of claim 10, wherein the at least one story is provided to the user via the user database as a first webpage or website and the at least one game is presented to the user via the user database as a second webpage or website.

12. The method of claim 10, wherein the user communication unit is selected from the group consisting of a communication with the one or more characters in at least one of the stories, a communication with one or more other users, commentary regarding the one or more characters or the one or more plots, and participation in a poll or quiz.

13. The method of claim 10, wherein providing the story comprises transmitting the plurality of communication units from the content creator via at least one medium selected from the group consisting of: a cell phone text message, a visual cell phone transmission, a cell phone voice transmission, a land line voice transmission, a blog posting on a webpage, a micro-blog posting on a webpage, a written, visual, audio or video posting on a webpage, participation in an interactive activity on a webpage, a posting on a social networking website, a video transmitted by a television channel, and an audio transmission transmitted by a television channel or by a radio channel.

14. The method of claim 10, wherein the method further comprises sending a story enrichment unit in response to the completion of one of the obstacles of the game, wherein the story enrichment unit modifies a plot or a character of the at least one story.

15. The method of claim 10, wherein the value indicates the effectiveness of the at least one gaming unit for completing one of the obstacles of the game.

16. The method of claim 10, wherein the method further comprises transmitting, over the user interface, a story participation point to the user in return for the received user communication unit.

17. The method of claim 16, wherein the method further comprises
receiving from a user a request to exchange the story participation point for at least one gaming unit; and
transmitting, over the user interface, a gaming unit to the user in exchange for the story participation point.

18. The method of claim 10, wherein the one or more obstacles are completed by a single user or a plurality of users.

19. An entertainment system for providing an interactive story and an interactive game to a user over a computing device, the system comprising a memory and a processor configured to:
store at least one story comprising a plurality of communication units in a content database, wherein a portion of the communication units corresponds to one or more characters in the story and a portion of communication units corresponds to one or more plots in the story;
store at least one game corresponding to the story in the content database, wherein the game involves one or more obstacles for completion by at least one user and comprises a plurality of gaming units, wherein one or more gaming units are associated with a value and are selected from the group consisting of a character selected from the story for use in the game, a tool for use in the game, and a gameplay element affecting the course of the game;
provide the story and the game to a user via a user interface;
receive a plurality of user communication units related to the story from one or more users via the user interface;
aggregate the plurality of user communication units; and
adjust the value of the gaming unit based on the aggregated user communication units.

20. An entertainment system for providing an interactive story and an interactive game to a user over a computing device, the system comprising a memory and a processor configured to:
store at least one story comprising a plurality of communication units in a content database, wherein a portion of the communication units corresponds to one or more characters in the story and a portion of communication units corresponds to one or more plots in the story;
store at least one game corresponding to the story in the content database, wherein the game involves one or more obstacles for completion by at least one user and comprises a plurality of gaming units, wherein one or more gaming units are selected from the group consisting of a character selected from the story for use in the game, a tool for use in the game, and a gameplay element affecting the course of the game;
receive, via the user interface, a plurality of user communication units related to the story from one or more users;
transmit, over the user interface, a story participation point to one or more users in return for the received user communication units;
receive from a user a request to exchange the story participation point for at least one gaming unit; and
transmit, over the user interface, a gaming unit to the user in exchange for the story participation point.
